(19) United States
(12) Patent Application Publication
(10) Pub. No.: US 2025/0024849 A1
(43) Pub. Date: Jan. 23, 2025

(54) ANTIOXIDANT COMPOSITION, AND EDIBLE OIL AND FAT

(71) Applicant: FTT CO., LTD., Suzuka-Shi (JP)

(72) Inventors: Takashi IWATA, Suzuka-Shi (JP); Ai UESHIMA, Matsusaka-Shi (JP); Yuki FUJIMOTO, Matsusaka-Shi (JP); Akihito HAYASHI, Matsusaka-Shi (JP)

(73) Assignee: FTT CO., LTD., Suzuka-Shi (JP)

(21) Appl. No.: 18/904,117

(22) Filed: Oct. 2, 2024

Related U.S. Application Data
(63) Continuation of application No. PCT/JP2023/015540, filed on Apr. 19, 2023.

(30) Foreign Application Priority Data
Apr. 27, 2022 (JP) 2022-072993

(51) Int. Cl. A23D 9/007

(52) U.S. Cl. CPC A23D 9/007

(57) ABSTRACT

The antioxidant composition contains an edible oil and fat, an antioxidant component sparingly soluble in an oil and fat, and an emulsifier, wherein the emulsifier is composed of a diglycerol oleic acid ester having a monoester content of 40% or more and less than 70% and lecithin, and the antioxidant component is solubilized by the emulsifier without using an aqueous solvent. An edible oil and fat of the present invention contains the antioxidant composition in an amount of 0.01 parts by mass or more and 30 parts by mass or less in 100 parts by mass of a total of the edible oil and fat and the antioxidant composition.

### TECHNICAL FIELD

The present invention relates to an antioxidant composition and an edible oil and fat containing the antioxidant composition.

### BACKGROUND ART

Food loss reduction is required also to achieve Goal 12: “by 2030, halve per capita global food waste at the retain and consumer levels and reduce food losses along production and supply chains, including post-harvest losses” of the UN-led Sustainable Development Goals (SDGs). Extending best-before dates or use-by dates of processed foods is an important approach for reducing food losses.

A best-before date of a processed food using an oil and fat is greatly affected by oxidative degradation of the oil and fat. Conventionally, various antioxidants are added to oils and fats in order to suppress oxidative degradation of the oils and fats. Currently, vitamins E and C are often used as antioxidants in Japan. However, their antioxidant effect cannot be said to be sufficient. For example, instant noodles have a best-before date of about 6 to 8 months, and a more effective antioxidant is required also due to this fact.

Examples of highly effective oil-soluble antioxidants include synthetic antioxidants such as dibutyl hydroxytoluene (BHT), butyl hydroxyanisole (BHA), and tertiary butylhydroquinone (TBHQ), but these synthetic antioxidants tend to be refrained from being used due to safety problems.

Therefore, tea catechin or the like is used as a naturally occurring antioxidant component having high safety and antioxidative property. However, many of the naturally occurring antioxidant components have a problem that they are soluble in water and alcohols but are sparingly soluble in oils and fats.

In addition, propyl gallate, ascorbic acid fatty acid ester, and the like, which are made oil-soluble by esterifying naturally occurring antioxidant components that are sparingly soluble in oils and fats, are known. For the solubility in oils and fats, these oil-soluble antioxidant components are also at most “hardly soluble” as described in the Handbook of the Japanese Standards of Food Additives, and are sparingly soluble in oils and fats. Furthermore, these oil-soluble antioxidant components have a high melting point of 100° C. or higher, and thus are added to a heated high-temperature oil and fat, but there is a problem that the antioxidant components are easily solidified and deposited when the temperature of the oil and fat in which they are dissolved is lowered.

Thus, when the oil and fat containing the oil-soluble antioxidant component is used for low-temperature cooking at, for example, about 75° C. or lower, or used in a processed food in which an oil and fat is not heated to a high temperature, such as a pouring oil for a rice cracker or snack food, or dressing (including semi-solid dressing, emulsified liquid dressing, and separated liquid dressing), the oil-soluble antioxidant component may be solidified and deposited in the production process.

In particular, in the case of propyl gallate, the maximum use amount is set to 0.10 g/kg or less in butter and 0.20 g/kg or less in edible oil and fat in the use standard defined by the Ministry of Health, Labour and Welfare. However, there is also a problem that, when added propyl gallate is deposited in a food and becomes heterogeneous, the use amount may partially exceed the upper limit.

Therefore, as described in Patent Literatures 1 and 2, an antioxidant component sparingly soluble in an oil and fat is once dissolved in water, an organic solvent, or the like, and then mixed with an emulsifier to prepare an emulsification composition or solubilization composition soluble in an oil and fat, and the composition is dispersed or dissolved in an oil and fat.

However, in antioxidant compositions described in Patent Literatures 1 and 2, the antioxidant component is in a so-called diluted state by the aqueous solvent, and thus a substantial content of the antioxidant component in the antioxidant compositions is relatively small. For this reason, in order to obtain a sufficient antioxidant effect, the addition amount of the antioxidant composition is increased, which has a problem that the oil and fat becomes easily turbid.

As shown in FIG. 1, in an antioxidant composition 9 described in Patent Literature 1 or 2, an aqueous phase portion W exists between an antioxidant component AC dissolved in an aqueous solvent and an emulsifier E. Hence, the antioxidant component AC is indirectly involved in an oil and fat component O via the aqueous phase portion W, and may not be able to sufficiently exhibit its original antioxidant capability.

Therefore, as described in Patent Literature 3, attempts have also been made to solubilize an antioxidant component without dissolving it in an aqueous solvent. However, an antioxidant composition described in Patent Literature 3 is a water syrup-like composition having a very high viscosity, and has a problem of being difficult to dissolve in an edible oil and fat.

### CITATIONS LIST

### Patent Literature

Patent Literature 1: JP 2001-131572 A
Patent Literature 2: JP 2008-163202 A
Patent Literature 3: JP 5786215 B

### SUMMARY OF INVENTION

### Technical Problems

An object of the present invention is to solve the above-described conventional problems, and to provide an antioxidant composition which can provide a high antioxidant effect by solubilizing an antioxidant component without via an aqueous solvent, and which is easily dissolved in an oil and fat, and an edible oil and fat containing the antioxidant composition.

### Solutions to Problems

In order to solve the above problems, there is provided an antioxidant composition containing: an edible oil and fat; an antioxidant component sparingly soluble in an oil and fat; and an emulsifier, wherein the emulsifier contains a diglycerol oleic acid ester having a monoester content of 40% or more and less than 70% and lecithin, a content of the antioxidant component is 0.5 parts by mass or more and 40 parts by mass or less, a content of the diglycerol oleic acid ester is 1 part by mass or more and less than 70 parts by mass, and a content of the lecithin is 0.1 parts by mass or more and 40 parts by mass or less, with respect to 100 parts by mass of the antioxidant composition, and the antioxidant component is solubilized by the emulsifier without using an aqueous solvent.

The antioxidant component is preferably one type or two or more types selected from polyphenols, gallic acid, propyl gallate, and ascorbic acid fatty acid ester.

The antioxidant composition preferably further contains one organic acid or two or more organic acids selected from citric acid, malic acid, phosphoric acid, polyphosphoric acid, metaphosphoric acid, lactic acid, succinic acid, fumaric acid, gluconic acid, tartaric acid, phytic acid, ascorbic acid, EDTA, and salts thereof.

Also, there is provided an edible oil and fat to which any one of the above-described antioxidant compositions is added, wherein any one of the above-described antioxidant compositions is contained in an amount of 0.01 parts by mass or more and 30 parts by mass or less in 100 parts by mass of the edible oil and fat.

### Advantageous Effects of Invention

The present invention can provide an antioxidant composition which can provide a high antioxidant effect by solubilizing an antioxidant component without via an aqueous solvent, and which is easily dissolved in an oil and fat, and an edible oil and fat containing the antioxidant composition.

In addition, this makes it possible to improve the oxidation stability of the oil and fat and extend the best-before date of the food, resulting in contribution to Goal 12 of the UN-led Sustainable Development Goals (SDGs) described above.

### BRIEF DESCRIPTION OF DRAWINGS

FIG. 1 is an explanatory view showing a structure of an emulsified particle of a conventional antioxidant composition.

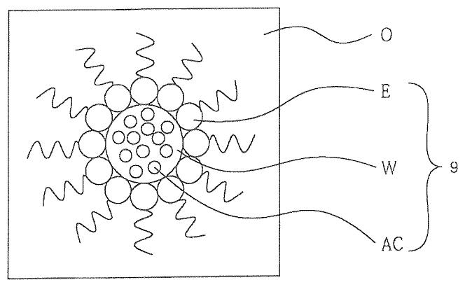

### DESCRIPTION OF EMBODIMENT

### (Antioxidant Composition)

Hereinafter, an embodiment of the invention will be illustrated. An antioxidant composition of the present invention contains an edible oil and fat, an antioxidant component sparingly soluble in an oil and fat, and an emulsifier. In the present invention, a diglycerol oleic acid ester having a monoester content of 40% or more and less than 70% and lecithin are used as the emulsifier, as will be described in detail later. As a result, the antioxidant component sparingly soluble in an oil and fat is satisfactorily solubilized without via an aqueous solvent.

### (Edible Oil and Fat)

Examples of the edible oil and fat used in the present invention include vegetable oils and fats such as rapeseed oil, soybean oil, corn oil, rice oil, olive oil, sesame oil, safflower oil, cottonseed oil, sunflower oil, peanut oil, palm oil, palm kernel oil, coconut oil, almond oil, avocado oil, jojoba oil, and cacao fat; animal oils and fats such as beef tallow, lard, fish oil, fish liver oil, and whale oil; medium-chain fatty acid triglycerides; and/or processed oils and fats obtained by subjecting these oils and fats to processing treatment such as fractionation, hydrogenation, or transesterification. A mixed oil and fat obtained by combining two or more types of these oils and fats can also be used, but the present invention is not limited thereto. A content of the edible oil and fat is not particularly limited, but is preferably 10 parts by mass or more and 80 parts by mass or less with respect to 100 parts by mass of the antioxidant composition, from the viewpoints of improving the solubility and viscosity of the antioxidant composition in an oil and fat.

### (Antioxidant Component)

Examples of the antioxidant component sparingly soluble in an oil and fat, which is used in the present invention, include polyphenols, gallic acid, propyl gallate, and ascorbic acid fatty acid ester. As the polyphenols, green tea extract (including catechin, epicatechin, gallocatechin, epigallocatechin, catechin gallate, epicatechin gallate, gallocatechin gallate, and epigallocatechin gallate) is preferably used, but one type or two or more types of other polyphenols having an antioxidant effect can be used in combination. Two or more types of these antioxidant components may be used in combination.

A content of the antioxidant component is not particularly limited, but is preferably 40 parts by mass or less, more preferably 30 parts by mass or less, and still more preferably 0.5 parts by mass or more and 20 parts by mass or less in 100 parts by mass of the antioxidant composition, from the viewpoints of exerting an antioxidant action, good solubilization and stability, and the like.

In addition, in the present invention, one antioxidant component or two or more antioxidant components selected from rosemary extract, ginger extract, vitamin A, vitamin D, and vitamin E as fat-soluble vitamins, and the like may be appropriately added, in addition to the above-described antioxidant component.

### (Diglycerol Oleic Acid Ester)

In the antioxidant composition of the present invention, a diglycerol oleic acid ester having a monoester content of 40% or more and less than 70% is used as the emulsifier. The diglycerol oleic acid ester is preferred because it is liquid at normal temperature and dissolves well in oils and fats. However, the use of a diglycerol oleic acid ester having a monoester content of 70% or more increases the viscosity of the antioxidant composition, making it difficult to add the composition to an edible oil and fat. In addition, a content of the diglycerol oleic acid ester in the present invention is preferably less than 70 parts by mass, and more preferably 1 part by mass or more and 65 parts by mass or less with respect to 100 parts by mass of the antioxidant composition, from the viewpoints of good solubilization of the antioxidant component and dispersion stability. The content is most preferably 7 parts by mass or more and 60 parts by mass or less.

The use of the diglycerol oleic acid ester and lecithin which will be described later as the emulsifier makes it possible to satisfactorily solubilize a water-soluble antioxidant component (catechin, gallic acid, or the like) that does not mix with an oil and fat and is easily precipitated, without using an aqueous solvent.

In addition, the diglycerol oleic acid ester has an action of lowering the melting point of a composition containing an oil-soluble antioxidant component (such as propyl gallate and ascorbyl palmitate) that is sparingly soluble in an oil and fat. The oil-soluble antioxidant component added to an edible oil and fat is dissolved at an oil temperature of about 110 to 130° C. in the absence of the diglycerol oleic acid ester, and deposited and solidified again when the oil temperature lowers. However, the component is solubilized at 70 to 110° C. in the presence of the diglycerol oleic acid ester, and can maintain a solubilized state without being deposited even when the oil temperature lowers. This makes it possible to satisfactorily solubilize the oil-soluble antioxidant component sparingly soluble in an oil and fat without using an aqueous solvent such as ethanol.

### (Lecithin)

In the present invention, lecithin is used as the emulsifier, in addition to the diglycerol oleic acid ester. Upon addition of lecithin, the components in the antioxidant composition are uniformly dissolved, resulting in an improved dispersion stability. A content of the lecithin in the present invention is preferably 40 parts by mass or less, and more preferably 30 parts by mass or less with respect to 100 parts by mass of the antioxidant composition, from the viewpoints of maintaining the dispersion stability of the antioxidant composition, obtaining good color tone and viscosity, and the like. The content is most preferably 0.1 parts by mass or more and 20 parts by mass or less.

The lecithin used in the present invention is preferably a purified lecithin. Further, the lecithin includes purified phosphatidylcholine as its active ingredient, and has a phosphatidylcholine content of preferably 50% or more, and more preferably 70% or more. The use of lecithin having a high phosphatidylcholine content makes it possible to suppress a browning phenomenon at a high temperature (about 180° C.), which is a drawback of lecithin, so that an antioxidant composition that is less likely to be discolored even when the edible oil and fat to which the composition is added is subjected to heating cooking can be obtained.

In the present invention, the use of the diglycerol oleic acid ester and the lecithin as the emulsifier, as described above, makes it possible to satisfactorily solubilize any sparingly soluble antioxidant component that is water-soluble or oil-soluble. Therefore, not only when a water-soluble or oil-soluble antioxidant component is used alone, but also when both of the antioxidant components are used in combination, an antioxidant composition which provides good solubilization of the antioxidant component(s) and has excellent dispersion stability can be obtained.

(Emulsifier that can be Used in Combination)

Another emulsifier can be further added to the antioxidant composition of the present invention. For example, one emulsifier or two or more emulsifiers selected from monoglycerol fatty acid ester, glycerol organic acid fatty acid ester, diglycerol fatty acid ester, polyglycerol fatty acid ester, sucrose fatty acid ester, propylene glycol fatty acid ester, sorbitan fatty acid ester, enzymatically decomposed lecithin, enzyme-treated lecithin, and the like can be used.

### (Organic Acid)

An organic acid can be added to the antioxidant composition of the present invention. In the present invention, one organic acid or two or more organic acids selected from citric acid, malic acid, phosphoric acid, polyphosphoric acid, metaphosphoric acid, lactic acid, succinic acid, fumaric acid, gluconic acid, tartaric acid, phytic acid, ascorbic acid, EDTA, and salts thereof can be used. These organic acids themselves have an antioxidant effect, synergistically enhance the antioxidant effect of other antioxidant components as synergists, and also have a chelating action. However, there is a problem that they are difficult to dissolve in an oil and fat.

### (Production Method)

A method for producing the antioxidant composition of the present invention will be described. The antioxidant composition of the present invention is obtained by mixing an edible oil and fat, a diglycerol oleic acid ester having a monoester content of less than 70%, and lecithin, heating and dissolving the mixture, further adding an antioxidant component sparingly soluble in an oil and fat, and heating and dissolving the mixture. At this time, the antioxidant component sparingly soluble in an oil and fat is directly added without being dissolved in an aqueous solvent selected from the group consisting of water, a monohydric alcohol, a polyhydric alcohol, and a reduced starch decomposition product.

The antioxidant composition of an embodiment is obtained by: adding less than 70 parts by mass of a diglycerol oleic acid ester molten by heating to 60° C. and 40 parts by mass or less of lecithin to 10 parts by mass or more and 80 parts by mass or less of an edible oil and fat; stirring the mixture uniformly with a mixer or the like while heating to 70° C. to 80° C.; then adding 0.01 parts by mass or more and 40 parts by mass or less of an antioxidant component that is sparingly soluble in an oil and fat thereto; stirring the mixture while heating to 70 to 130° C.; and dispersing and dissolving the mixture.

The antioxidant composition obtained by the above method can be contained in an edible oil and fat for heating cooking and/or non-heating cooking. Here, the phrase “for heating cooking” means that the edible oil and fat is heated and used in cooking of instant noodles, potato chips, fried confectioneries, side dishes, and the like. In addition, the phrase “for non-heating cooking” means that the edible oil and fat is used without being heated to a high temperature in cooking including spraying to a rice cracker or snack food, dipping, pouring application (pouring oil), dressing, and the like.

The antioxidant composition is preferably contained in an amount of 0.01 parts by mass or more and 30 parts by mass or less in 100 parts by mass of an edible oil and fat for heating cooking and/or non-heating cooking to which the antioxidant composition is added. When the addition amount is smaller than this, the antioxidant effect is weakened. When the addition amount is larger than this, the edible oil and fat is not suitable as an edible oil and fat. The addition amount is more preferably 0.1 parts by mass or more and 10 parts by mass or less, and still more preferably 1 part by mass or more and 10 parts by mass or less. Among the antioxidant components, those defined in maximum limit of the use amount by a use standard will be added in an amount conforming to the regulation.

An organic acid can be further added to the edible oil and fat for heating cooking and/or non-heating cooking to which the antioxidant composition of the present invention is added. Examples of the organic acid which can be added to the edible oil and fat include, but are not limited to, one organic acid or two or more organic acids selected from citric acid, malic acid, phosphoric acid, polyphosphoric acid, metaphosphoric acid, lactic acid, succinic acid, fumaric acid, gluconic acid, tartaric acid, phytic acid, ascorbic acid, EDTA, and salts thereof.

The antioxidant composition obtained by the above method is an antioxidant composition in which a diglycerol oleic acid ester is uniformly dispersed in an oil phase. When an antioxidant component that is sparingly soluble in an oil and fat is mixed in an oil phase in which such an emulsifier is uniformly dispersed, without being dissolved in an aqueous solvent, the antioxidant component is solubilized in the oil and fat by the emulsifier. At this time, the antioxidant component is not dissolved in an aqueous solvent, and thus an aqueous phase portion is not substantially provided around the antioxidant component. The antioxidant composition is substantially free of the aqueous solvent, that is, the aqueous phase portion. As a result, the solubilized antioxidant component can be directly involved in the oil and fat without via the aqueous phase, and can exhibit high antioxidant capability.

Hence, the present invention can provide an antioxidant composition which can provide a high antioxidant effect by solubilizing an antioxidant component without via an aqueous solvent, and which is easily dissolved in an oil and fat.

### EXAMPLES

Hereinafter, the present invention will be described in detail with reference to Examples. Note that the present invention is not limited to these examples. Raw materials of Examples and Comparative Examples are as follows.

### (Edible Oil and Fat)

Rapeseed oil (trade name: Refined Rapeseed Oil, manufactured by Tsuji Oil Mills Co., Ltd.)

### (Diglycerol Oleic Acid Ester)

The diglycerol oleic acid esters used in Examples are mixtures of the following two types of diglycerol oleic acid esters (both manufactured by Riken Vitamin Co., Ltd.).
Trade name: Poem DO-100V (monoester content: 80%)
Trade name: RIKEMAL JV-2681 (monoester content: 41%)
   (Emulsifier Other than Diglycerol Oleic Acid Ester)

The emulsifiers used in Comparative Examples are as follows (all manufactured by Riken Vitamin Co., Ltd.).
Monoglycerol oleic acid ester (trade name: Poem OL-200V)
Propylene glycol oleic acid ester (trade name: RIKEMAL PO-100V)
Citric and fatty acid esters of glycerol (trade name: Poem K-37V)
Polyglycerol condensed ricinoleic acid ester (trade name: Poem PR-300)

### (Lecithin)

The types of lecithin used in Examples and Comparative Examples are the following two types of lecithin (all manufactured by Tsuji Oil Mills Co., Ltd.), and the phosphatidylcholine contents (hereinafter referred to as “PC content”) with respect to the total phospholipid in these types of lecithin are as follows.
SLP-Paste (PC content: 30%)
SLP-PC70 (PC content: 70%)

### (Antioxidant Component)

The antioxidant components used in Examples and Comparative Examples are as follows.
Propyl gallate (manufactured by Fuji Chemical Industries Co., Ltd.)
Gallic acid (manufactured by Fuji Chemical Industries Co., Ltd.)
Ascorbic acid fatty acid ester (vitamin C palmitate, manufactured by Mitsubishi Chemical Corporation)
Green tea extract (trade name: Sunphenon 100S, manufactured by Taiyo Kagaku Co., Ltd.)

### (Formulations of Examples and Comparative Examples)

The formulation compositions of Examples and Comparative Examples prepared using the raw materials described above are shown in Table 1.

TABLE 1A
(unit: mass %)

| | | | Emulsifier | | | | | | | |
|---|---|---|---|---|---|---|---|---|---|---|
| A: Antioxidant | | | (Type) | Diglycerol oleic | | | | | Citric and | Polyglycerol |
| composition | | | (Product | acid ester | | | Monoglycerol | Propylene | fatty acid | condensed |
| B: Edible oil | | | name) | DO- | JV- | | oleic acid | glycol oleic | esters of | ricinoleic |
| and fat to which | | Rapeseed | (Monoester | 100V | 2681 | | ester | acid ester | glycerol | acid ester |
| A is added | | oil | content) | 80% | 41% | (Subtotal) | OL-200V | PO-100V | K-37V | PR-300 |
| A | Example 1 | 38.00 | | 40.00 | 20.00 | 60.00 | | | | |
| A | Example 2 | 73.00 | | 0.00 | 25.00 | 25.00 | | | | |
| A | Example 3 | 38.00 | | 40.00 | 20.00 | 60.00 | | | | |
| A | Example 4 | 33.00 | | 40.00 | 20.00 | 60.00 | | | | |
| B | Example 5 | 98.66 | | 0.80 | 0.40 | 1.20 | | | | |
| B | Example 6 | 98.76 | | 0.80 | 0.40 | 1.20 | | | | |
| A | Example 7 | 32.00 | | 33.34 | 16.66 | 50.00 | | | | |
| A | Example 8 | 37.00 | | 40.00 | 20.00 | 60.00 | | | | |
| A | Example 9 | 36.00 | | 38.65 | 19.35 | 58.00 | | | | |
| A | Example 10 | 38.00 | | 40.00 | 20.00 | 60.00 | | | | |
| A | Example 11 | 36.00 | | 38.65 | 19.35 | 58.00 | | | | |
| A | Example 12 | 38.00 | | 40.00 | 20.00 | 60.00 | | | | |

| A: Antioxidant | | | Antioxidant component | | | | | | | | |
|---|---|---|---|---|---|---|---|---|---|---|---|
| composition | | | | | | Green | Organic acid | | | | |
| B: Edible oil | | | Propyl | Gallic | Ascorbyl | tea | 50% | 50% | | | |
| and fat to which | | Emulsifier | gallate | acid | palmitate | extract | Citric | Phytic | | | |
| A is added | | Lecithin | P.G | G.A | V.C-P | T.E | acid | acid | Ethanol | Total | Remarks |
| A | Example 1 | 1.00 | 1.00 | | | | | | | 100.00 | |
| A | Example 2 | 1.00 | 1.00 | | | | | | | 100.00 | |
| A | Example 3 | 1.00 | 1.00 | | | | | | | 100.00 | |
| A | Example 4 | 6.00 | 1.00 | | | | | | | 100.00 | |
| B | Example 5 | 0.12 | 0.02 | | | | | | | 100.00 | Example 4 |
| | | | | | | | | | | | added in 2% |
| | | | | | | | | | | | to oil |
| B | Example 6 | 0.02 | 0.02 | | | | | | | 100.00 | Example 3 |
| | | | | | | | | | | | added in 2% |
| | | | | | | | | | | | to oil |
| A | Example 7 | 1.00 | 17.00 | | | | | | | 100.00 | |
| A | Example 8 | 1.00 | | 2.00 | | | | | | 100.00 | |
| A | Example 9 | 1.00 | | 5.00 | | | | | | 100.00 | |
| A | Example 10 | 1.00 | | | 1.00 | | | | | 100.00 | |
| A | Example 11 | 1.00 | | | 5.00 | | | | | 100.00 | |
| A | Example 12 | 1.00 | | | | 1.00 | | | | 100.00 | |

TABLE 1B
(unit: mass %)

| | | | Emulsifier | | | | | | | |
|---|---|---|---|---|---|---|---|---|---|---|
| A: Antioxidant | | | (Type) | Diglycerol oleic | | | | | Citric and | Polyglycerol |
| composition | | | (Product | acid ester | | | Monoglycerol | Propylene | fatty acid | condensed |
| B: Edible oil | | | name) | DO- | JV- | | oleic acid | glycol oleic | esters of | ricinoleic |
| and fat to which | | Rapeseed | (Monoester | 100V | 2681 | | ester | acid ester | glycerol | acid ester |
| A is added | | oil | content) | 80% | 41% | (Subtotal) | OL-200V | PO-100V | K-37V | PR-300 |
| A | Example 13 | 39.00 | | 36.65 | 18.35 | 55.00 | | | | |
| B | Example 14 | 99.39 | | 0.37 | 0.18 | 0.55 | | | | |
| A | Example 15 | 37.00 | | 40.00 | 20.00 | 60.00 | | | | |
| A | Example 16 | 37.00 | | 40.00 | 20.00 | 60.00 | | | | |
| B | Example 17 | 97.44 | | 1.55 | 0.77 | 2.32 | | | | |
| A | Example 18 | 40.00 | | 12.00 | 6.00 | 18.00 | | | | |
| | Example 19 | 71.75 | | 5.00 | 2.50 | 7.50 | | | | |
| | Comparative | | | 98.00 | | 98.00 | | | | |
| | Example 1 | | | | | | | | | |
| | Comparative | 28.00 | | 70.00 | | 70.00 | | | | |
| | Example 2 | | | | | | | | | |
| | Comparative | 98.00 | | | | | | | | |
| | Example 3 | | | | | | | | | |
| | Comparative | 38.0 | | | | | 60.00 | | | |
| | Example 4 | | | | | | | | | |
| | Comparative | 38.00 | | | | | | 60.00 | | |
| | Example 5 | | | | | | | | | |
| | Comparative | 99.98 | | | | | | | | |
| | Example 6 | | | | | | | | | |

| A: Antioxidant | | | Antioxidant component | | | | | | | | |
|---|---|---|---|---|---|---|---|---|---|---|---|
| composition | | | | | | Green | Organic acid | | | | |
| B: Edible oil | | | Propyl | Gallic | Ascorbyl | tea | 50% | 50% | | | |
| and fat to which | | Emulsifier | gallate | acid | palmitate | extract | Citric | Phytic | | | |
| A is added | | Lecithin | P.G | G.A | V.C-P | T.E | acid | acid | Ethanol | Total | Remarks |
| A | Example 13 | 1.00 | | | | 5.00 | | | | 100.00 | |
| B | Example 14 | 0.01 | | | | 0.05 | | | | 100.00 | Example 13 |
| | | | | | | | | | | | added in 1% |
| | | | | | | | | | | | to oil |
| A | Example 15 | 1.00 | 1.00 | | | | 1.00 | | | 100.00 | |
| A | Example 16 | 1.00 | 1.00 | | | | | 1.00 | | 100.00 | |
| B | Example 17 | 0.04 | | 0.20 | | | | | | 100.00 | Example 9 |
| | | | | | | | | | | | added in 4% |
| | | | | | | | | | | | to oil |
| A | Example 18 | 40.00 | 2.00 | | | | | | | 100.00 | |
| | Example 19 | 20.00 | | | 0.25 | 0.50 | | | | 100.00 | |
| | Comparative | 1.00 | 1.00 | | | | | | | 100.00 | |
| | Example 1 | | | | | | | | | | |
| | Comparative | 1.00 | 1.00 | | | | | | | 100.00 | |
| | Example 2 | | | | | | | | | | |
| | Comparative | 1.00 | 1.00 | | | | | | | 100.00 | |
| | Example 3 | | | | | | | | | | |
| | Comparative | 1.00 | 1.00 | | | | | | | 100.00 | |
| | Example 4 | | | | | | | | | | |
| | Comparative | 1.00 | 1.00 | | | | | | | 100.00 | |
| | Example 5 | | | | | | | | | | |
| | Comparative | | 0.02 | | | | | | | 100.00 | |
| | Example 6 | | | | | | | | | | |

TABLE 1C
(unit: mass %)

| | | | Emulsifier | | | | | | | |
|---|---|---|---|---|---|---|---|---|---|---|
| A: Antioxidant | | | (Type) | Diglycerol oleic | | | | | Citric and | Polyglycerol |
| composition | | | (Product | acid ester | | | Monoglycerol | Propylene | fatty acid | condensed |
| B: Edible oil | | | name) | DO- | JV- | | oleic acid | glycol oleic | esters of | ricinoleic |
| and fat to which | | Rapeseed | (Monoester | 100V | 2681 | | ester | acid ester | glycerol | acid ester |
| A is added | | oil | content) | 80% | 41% | (Subtotal) | OL-200V | PO-100V | K-37V | PR-300 |
| | Comparative | | | | | | | | 30.00 | 50.00 |
| | Example 7 | | | | | | | | | |
| | Comparative | 99.00 | | | | | | | 0.30 | 0.50 |
| | Example 8 | | | | | | | | | |
| | Comparative | 100.00 | | | | | | | | |
| | Example 9 | | | | | | | | | |
| | Comparative | 20.00 | | 12.00 | 6.00 | 18.00 | | | | |
| | Example 10 | | | | | | | | | |

| A: Antioxidant | | | Antioxidant component | | | | | | | | |
|---|---|---|---|---|---|---|---|---|---|---|---|
| composition | | | | | | Green | Organic acid | | | | |
| B: Edible oil | | | Propyl | Gallic | Ascorbyl | tea | 50% | 50% | | | |
| and fat to which | | Emulsifier | gallate | acid | palmitate | extract | Citric | Phytic | | | |
| A is added | | Lecithin | P.G | G.A | V.C-P | T.E | acid | acid | Ethanol | Total | Remarks |
| | Comparative | | | | | 5.00 | | | 15.00 | 100.00 | |
| | Example 7 | | | | | | | | | | |
| | Comparative | | | | | 0.05 | | | 0.15 | 100.00 | Comparative |
| | Example 8 | | | | | | | | | | Example 7 |
| | | | | | | | | | | | added in 1% |
| | | | | | | | | | | | to oil |
| | Comparative | | | | | | | | | 100.00 | |
| | Example 9 | | | | | | | | | | |
| | Comparative | 60.00 | 2.00 | | | | | | | 100.00 | |
| | Example 10 | | | | | | | | | | |

### (Preparation Method)

Examples and Comparative Examples were prepared by the following method so as to attain the formulation compositions shown in Table 1.

### Example 1

(1) The following two types of diglycerol oleic acid esters were mixed in the following proportions to obtain a diglycerol oleic acid ester having a substantial monoester content of 67%.
Poem DO-100V: 40 mass %
RIKEMAL JV-2681: 20 mass %
   (2) Sixty (60) mass % of the diglycerol oleic acid ester dissolved at 60° C. and 1 mass % of lecithin (SLP-PC70: manufactured by Tsuji Oil Mills Co., Ltd.) were mixed with 38 mass % of rapeseed oil by propeller stirring for 10 minutes; 1 mass % of an antioxidant component (propyl gallate: manufactured by Fuji Chemical Industries Co., Ltd.) was added; the temperature was further raised; and the mixture was mixed by propeller stirring for 10 minutes to obtain an antioxidant composition of Example 1.

### Examples 2 to 4, Examples 7 to 13, Examples 18 to 19, Comparative Examples 1 to 6, and Comparative Example 9

Antioxidant compositions of Examples 2 to 4, 7 to 13, 18 and 19, and Comparative Examples 2 to 6 were prepared so as to attain the compositions shown in Table 1 in the same manner as in Example 1. Comparative Example 1 is an antioxidant composition prepared in the same manner as in Example 1 except that rapeseed oil was not used. Comparative Example 9 is rapeseed oil.

### Examples 15 and 16

An antioxidant composition of Example 15 was obtained by adding 1 mass % of a 50% aqueous solution of citric acid as an organic acid to an antioxidant composition prepared in the same manner as in Example 1 except that the amount of rapeseed oil was 37 mass %, and stirring the mixture. In addition, an antioxidant composition of Example 16 was obtained by replacing the organic acid of Example 15 with 1 mass % of a 50% aqueous solution of phytic acid.

### Examples 5, 6, 14, and 17 of Edible Oils and Fats

Two (2) mass % of the antioxidant composition of Example 3 was added to 98 mass % of rapeseed oil to obtain an edible oil and fat of Example 5. Edible oils and fats of Examples 6, 14, and 17 shown in Table 1 were obtained in the same manner as in Example 5.

### Comparative Examples 7 and 8

An ethanol solution of catechin in which 5 mass % of an antioxidant component (green tea extract) was dissolved in 15 mass % of absolute ethanol was dissolved and mixed with 30 mass % of citric and fatty acid esters of glycerol (Poem K-37V), and this was further dissolved in and mixed with 50 mass % of polyglycerol condensed ricinoleic acid ester (Poem PR-300) to obtain an antioxidant composition of Comparative Example 7. In addition, 1 mass % of the antioxidant composition of Comparative Example 7 was added to 99 mass % of rapeseed oil, and the mixture was stirred to obtain an edible oil and fat of Comparative Example 8.

### (Test 1: Comparison in Monoester Content and Blending Amount of Diglycerol Oleic Acid Ester)

The appearance and viscosity were measured for the antioxidant compositions of Examples 1 and 2 and Comparative Example 1 to 3. The viscosity was measured under a condition of 20° C. using a rotational viscoelasticity measurement rheometer (AR-G2, manufactured by TA Instruments Japan Inc.). The results are shown in Table 2.

As is apparent from the results shown in Table 2, the antioxidant compositions of Example 1 using the diglycerol oleic acid ester having a monoester content of 67% and Example 2 using the diglycerol oleic acid ester having a monoester content of 41% were free from turbidity, precipitation, or separation, provided good solubilization of the antioxidant component, and had a good viscosity.

On the other hand, the antioxidant composition of Comparative Example 1 containing no rapeseed oil and using the diglycerol oleic acid ester having a monoester content of 80% had a very high viscosity. In addition, in the antioxidant composition of Comparative Example 2 containing rapeseed oil but using the diglycerol oleic acid ester having a monoester content of 80%, a high viscosity and separation of the components were observed. In the antioxidant composition of Comparative Example 3 containing no diglycerol oleic acid ester, the components were precipitated, and the antioxidant component was not uniformly dissolved. From these results, it was found that, when a diglycerol oleic acid ester having a monoester content of 70% or more is used, the viscosity and dispersibility of the antioxidant composition are not good.

TABLE 2
(unit: mass %)

| | | Emulsifier | | | | | | | | | |
|---|---|---|---|---|---|---|---|---|---|---|---|
| | | (Type) | Diglycerol oleic | | | | Antioxidant | | | | |
| | | (Product | acid ester | | | | component | | | | |
| | | name) | DO- | JV- | | | Propyl | | | | |
| | Rapeseed | (Monoester | 100V | 2681 | | Emulsifier | gallate | | Viscosity | | |
| | oil | content) | 80% | 41% | (Subtotal) | Lecithin | P.G | Total | (20° C.) | | Result |
| Example 1 | 38.00 | | 40.00 | 20.00 | 60.00 | 1.00 | 1.00 | 100.00 | 914 | mPa · s | Clear |
| Example 2 | 73.00 | | 0.00 | 25.00 | 25.00 | 1.00 | 1.00 | 100.00 | 188 | mPa · s | Clear |
| Comparative | | | 98.00 | | | 1.00 | 1.00 | 100.00 | 25,020 | mPa · s | High viscosity |
| Example 1 | | | | | | | | | | | |
| Comparative | 28.00 | | 70.00 | | | 1.00 | 1.00 | 100.00 | 4,659 | mPa · s | Separated |
| Example 2 | | | | | | | | | | | |
| Comparative | 98.00 | | | | | 1.00 | 1.00 | 100.00 | 94 | mPa · s | Precipitation |
| Example 3 | | | | | | | | | | | occurred |

### (Test 2: Comparison in Type of Emulsifier)

The results of measuring the appearances of the antioxidant compositions of Example 3 and Comparative Examples 4 and 5 are shown in Table 3. The antioxidant composition of Example 3 using the diglycerol oleic acid ester as the emulsifier exhibited a clear appearance due to solubilization of the antioxidant component, and had good dispersibility. On the other hand, in both of the antioxidant compositions of Comparative Example 4 using monoglycerol oleic acid ester as the emulsifier and Comparative Example 5 using propylene glycol oleic acid ester as the emulsifier, precipitation of the components was observed and the dispersibility was poor. From these results, it was found that a diglycerol oleic acid ester is suitable as the emulsifier to be added to the antioxidant composition.

TABLE 3

| | | Emulsifier | | | | | | | | | |
|---|---|---|---|---|---|---|---|---|---|---|---|
| | | (Type) | Diglycerol oleic | | | | | | Antioxidant | | |
| | | (Product | acid ester | | | Monoglycerol | Propylene | | component | | |
| | | name) | DO- | JV- | | oleic acid | glycol oleic | | Propyl | | |
| | Rapeseed | (Monoester | 100V | 2681 | | ester | acid ester | Emulsifier | gallate | | |
| | oil | content) | 80% | 41% | (Subtotal) | OL-200V | PO-100V | Lecithin | P.G | Total | Result |
| Example 3 | 38.00 | | 40.00 | 20.00 | 60.00 | | | 1.00 | 1.00 | 100.00 | Clear |
| Comparative | 38.00 | | | | | 60.00 | | 1.00 | 1.00 | 100.00 | Precipitation |
| Example 4 | | | | | | | | | | | occurred |
| Comparative | 38.00 | | | | | | 60.00 | 1.00 | 1.00 | 100.00 | Precipitation |
| Example 5 | | | | | | | | | | | occurred |

### (Test 3: Effect of Preventing Browning During Heating Due to Difference in PC Content of Lecithin)

As described above, lecithin has a property of browning at a high temperature (for example, 180° C., a heating temperature of a tempura (deep-fry) or the like). For this reason, when an edible oil and fat containing an antioxidant composition containing lecithin is heated for frying or the like, browning may be caused. Therefore, it is difficult to use lecithin in an edible oil and fat for high-temperature cooking. In Test 3, the appearance after heating was visually confirmed for Examples using lecithin different in PC content. The results are shown in Table 4.

Example 4 is an antioxidant composition prepared using lecithin having a general PC content, and Example 5 is an edible oil and fat to which Example 4 is added in 2%. Both of Examples 4 and 5 had a clear appearance when not heated. However, when the edible oil and fat of Example 5 was heated at 150° C. for 15 minutes, browning occurred, and the components were partially scorched and precipitated. The edible oil and fat of Example 5 was found to be unsuitable as an edible oil and fat for heating.

Example 3 is an antioxidant composition prepared using lecithin having a high PC content, and Example 6 is an edible oil and fat to which Example 3 is added in 2%. Both of Examples 3 and 6 had a clear appearance when not heated. Even when the edible oil and fat of Example 6 was heated at 150° C. for 15 minutes, neither browning nor scorching occurred.

From these results, it was found that, by using lecithin having a high PC content, an antioxidant composition suitable also for an edible oil and fat for heating cooking can be obtained. When lecithin having a general PC content is used, the obtained antioxidant composition is preferably used as an antioxidant composition to be added to an edible oil and fat for non-heating.

In Comparative Example 6, an antioxidant component (propyl gallate) was added to rapeseed oil without using an emulsifier, and the antioxidant component was not solubilized, and precipitation of the component occurred. Therefore, it is found that addition of an emulsifier is necessary for an antioxidant component to be favorably solubilized in an oil and fat.

TABLE 4
(unit: mass %)

| | | Emulsifier | | | | Emulsifier | | |
|---|---|---|---|---|---|---|---|---|
| | | (Type) | Diglycerol oleic | | | (Type) | | |
| | | (Product | acid ester | | | (Product | Lecithin | |
| | | name) | DO- | JV- | | name) | SLP- | SLP- |
| | Rapeseed | (Monoester | 100V | 2681 | | (PC | Paste | PC70 |
| | oil | content) | 80% | 41% | (Subtotal) | content) | 30% | 70% |
| Example 3 | 38.00 | | 40.00 | 20.00 | 60.00 | | | 1.00 |
| Example 4 | 33.00 | | 40.00 | 20.00 | 60.00 | | 6.00 | |
| Example 5 | 98.66 | | 0.80 | 0.40 | 1.20 | | 0.12 | |
| Example 6 | 98.76 | | 0.80 | 0.40 | 1.20 | | | 0.02 |
| Comparative | 99.98 | | | | | | | |
| Example 6 | | | | | | | | |

| | Antioxidant | | | | |
|---|---|---|---|---|---|
| | component | | | | Appearance |
| | Propyl | | | Appearance | after heating |
| | gallate | | | when not | at 150° C. for |
| | P.G | Total | Remarks | heated | 15 min |
| Example 3 | 1.00 | 100.00 | | Clear | — |
| Example 4 | 1.00 | 100.00 | | Clear | — |
| Example 5 | 0.02 | 100.00 | Example 4 | Clear | Browned and |
| | | | added in 2% | | scorched |
| | | | to oil | | |
| Example 6 | 0.02 | 100.00 | Example 3 | Clear | No browned |
| | | | added in 2% | | or scorched |
| | | | to oil | | |
| Comparative | 0.02 | 100.00 | | Precipitation | — |
| Example 6 | | | | occurred | |

### (Test 4: Type and Addition Amount of Antioxidant Component)

The results of visual observation of the appearances of the antioxidant compositions of Example 3 and Examples 7 to 13 different in type and addition amount of the antioxidant component are shown in Table 5. A clear appearance was observed in all Examples. From these results, it was found that, even when any of the above-described antioxidant components is used as the raw material, an antioxidant composition in which the antioxidant component is satisfactorily solubilized and which has good dispersion stability can be obtained. In particular, it was found that a clear composition can be prepared even when the blending proportion of propyl gallate with respect to the entire antioxidant composition is as high as 17 mass % as in Example 7.

TABLE 5
(unit: mass %)

| | | Emulsifier | | | | | | | | | | |
|---|---|---|---|---|---|---|---|---|---|---|---|---|
| | | (Type) | Diglycerol oleic | | | | Antioxidant component | | | | | |
| | | (Product | acid ester | | | | | | | Green | | |
| | | name) | DO- | JV- | | | Propyl | Gallic | Ascorbyl | tea | | |
| | Rapeseed | (Monoester | 100V | 2681 | | Emulsifier | gallate | acid | palmitate | extract | | |
| | oil | content) | 80% | 41% | (Subtotal) | Lecithin | P.G | G.A | V.C-P | T.E | Total | Appearance |
| Example 3 | 38.00 | | 40.00 | 20.00 | 60.00 | 1.00 | 1.00 | | | | 100.00 | Clear |
| Example 7 | 32.00 | | 33.34 | 16.66 | 50.00 | 1.00 | 17.00 | | | | 100.00 | Clear |
| Example 8 | 37.00 | | 40.00 | 20.00 | 60.00 | 1.00 | | 2.00 | | | 100.00 | Clear |
| Example 9 | 36.00 | | 38.65 | 19.35 | 58.00 | 1.00 | | 5.00 | | | 100.00 | Clear |
| Example 10 | 38.00 | | 40.00 | 20.00 | 60.00 | 1.00 | | | 1.00 | | 100.00 | Clear |
| Example 11 | 36.00 | | 38.65 | 19.35 | 58.00 | 1.00 | | | 5.00 | | 100.00 | Clear |
| Example 12 | 38.00 | | 40.00 | 20.00 | 60.00 | 1.00 | | | | 1.00 | 100.00 | Clear |
| Example 13 | 39.00 | | 36.65 | 18.35 | 55.00 | 1.00 | | | | 5.00 | 100.00 | Clear |

### (Test 5: Oxidation Stability Test)

A test for measuring oxidation stability was performed on the edible oils and fats to which the antioxidant compositions of Examples and Comparative Examples were added in predetermined proportions. The oxidation stability test was performed by a CDM test described in “Stability Test” of the Standards Methods for the Analysis of Fats, Oils and Related Materials (2013). The CDM test is an accelerated degradation test in which a sample is placed in a reaction vessel and clean air is sent while the sample is heated to 120° C., and a volatile decomposition product generated by oxidation is collected in water, and an induction time to a bending point at which the conductivity of water rapidly changes is measured. The larger the value of the induction time is, the more excellent the oxidation stability is. The antioxidant compositions used in the test, the blending proportions thereof to an edible oil and fat, and the induction times are as shown in Table 6.

The induction time in Comparative Example 9 (100% rapeseed oil) as a control condition was 5.8 hours. In Comparative Example 8 in which Comparative Example 7 obtained by dissolving green tea extract (catechin) in ethanol and then mixing the solution with an emulsifier was added in 1% to rapeseed oil, the induction time was 8.3 hours.

On the other hand, Example 14 in which the antioxidant composition of Example 13 (using catechin) was added in 1% to rapeseed oil had an induction time of 14.1 hours, and exhibited oxidation stability of 2 times or more as long as that of Comparative Example 9 and about 1.7 times as long as that of Comparative Example 8. Both of Example 14 and Comparative Example 8 used catechin as the antioxidant component, and were identical in mixing proportion of the antioxidant composition, i.e., 1%, but were remarkably different in induction time. This is considered to be an effect that, in the antioxidant composition of the present invention, the antioxidant component is not dissolved in an aqueous solvent, and directly acts on the oil and fat without via an aqueous phase.

In addition, the induction time of Example 14 in which the antioxidant composition of Example 9 (using gallic acid) was added in 4% to rapeseed oil was 12.3 hours, which was more than 2 times as long as that of Comparative Example 9.

TABLE 6
(unit: mass %)

| | | Emulsifier | | | | | |
|---|---|---|---|---|---|---|---|
| | | (Type) | Diglycerol oleic | | | citric and | Polyglycerol |
| | | (Product | acid ester | | | fatty acid | condensed |
| | | name) | DO- | JV- | | esters of | ricinoleic |
| | Rapeseed | (Monoester | 100V | 2681 | | glycerol | acid ester |
| | oil | content) | 80% | 41% | (Subtotal) | K-37V | PR-300 |
| Example 9 | 36.00 | | 38.65 | 19.35 | 58.00 | | |
| Example 13 | 39.00 | | 36.65 | 18.35 | 55.00 | | |
| Example 14 | 99.39 | | 0.37 | 0.18 | 0.55 | | |
| Example 17 | 97.44 | | 1.55 | 0.77 | 2.32 | | |
| Comparative | | | | | | 30.00 | 50.00 |
| Example 7 | | | | | | | |
| Comparative | 99.00 | | | | | 0.30 | 0.50 |
| Example 8 | | | | | | | |
| Comparative | 100.00 | | | | | | |
| Example 9 | | | | | | | |

| | | Antioxidant | | | | | |
|---|---|---|---|---|---|---|---|
| | | component | | | | | |
| | | | Green | | | | |
| | | Gallic | tea | | | | CDM test |
| | Emulsifier | acid | extract | | | | induction |
| | Lecithin | G.A | T.E | Ethanol | Total | Remarks | time |
| Example 9 | 1.00 | 5.00 | | | 100.00 | | — |
| Example 13 | 1.00 | | 5.00 | | 100.00 | | — |
| Example 14 | 0.01 | | 0.05 | | 100.00 | Example 13 | 14.1 h |
| | | | | | | added in 1% | |
| | | | | | | to oil | |
| Example 17 | 0.04 | 0.20 | | | 100.00 | Example 9 | 12.3 h |
| | | | | | | added in 4% | |
| | | | | | | to oil | |
| Comparative | | | 5.00 | 15.00 | 100.00 | | — |
| Example 7 | | | | | | | |
| Comparative | | | 0.05 | 0.15 | 100.00 | Comparative | 8.3 h |
| Example 8 | | | | | | Example 7 | |
| | | | | | | added in 1% | |
| | | | | | | to oil | |
| Comparative | | | | | 100.00 | | 5.8 h |
| Example 9 | | | | | | | |

### (Test 6: Addition of Organic Acid)

The appearances of Example 15 and Example 16 prepared by adding a 50% aqueous solution of citric acid and a 50% aqueous solution of phytic acid, respectively, as an organic acid, in 1% to the antioxidant composition of Example 1 were visually measured. The results are shown in Table 7. Both of Examples 15 and 16 were clear, and it was found that an organic acid difficult to dissolve in an oil and fat was well dissolved therein.

TABLE 7
(unit: mass %)

| | | Emulsifier | | | | | | | | | |
|---|---|---|---|---|---|---|---|---|---|---|---|
| | | (Type) | Diglycerol oleic | | | | Antioxidant | | | | |
| | | (Product | acid ester | | | | component | Organic acid | | | |
| | | name) | DO- | JV- | | | Propyl | 50% | 50% | | |
| | Rapeseed | (Monoester | 100V | 2681 | | Emulsifier | gallate | Citric | Phytic | | |
| | oil | content) | 80% | 41% | (Subtotal) | Lecithin | P.G | acid | acid | Total | Appearance |
| Example 15 | 37.00 | | 40.00 | 20.00 | 60.00 | 1.00 | 1.00 | 1.00 | | 100.00 | Clear |
| Example 16 | 37.00 | | 40.00 | 20.00 | 60.00 | 1.00 | 1.00 | | 1.00 | 100.00 | Clear |

### (Test 7: Study on Lecithin Content)

In order to study an appropriate upper limit value of the lecithin content, antioxidant compositions of Examples 18 and 19 and Comparative Example 10 having different lecithin contents were prepared, and their appearances were observed. The results are shown in Table 8. In Examples 18 and 19 having a lecithin content of 40 parts by mass or less with respect to 100 parts by mass of the antioxidant composition, a clear appearance was obtained, and the compositions were suitable for addition to an edible oil and fat. On the other hand, Comparative Example 10 having a lecithin content of 60 parts by mass with respect to 100 parts by mass of the antioxidant composition had a black color and a high viscosity. Therefore, the lecithin content is preferably 40 parts by mass or less.

TABLE 8
(unit: mass %)

| | | Emulsifier | | | | | | | | | | |
|---|---|---|---|---|---|---|---|---|---|---|---|---|
| | | (Type) | Diglycerol oleic | | | | Antioxidant component | | | | | |
| | | (Product | acid ester | | | | | | | Green | | |
| | | name) | DO- | JV- | | | Propyl | Gallic | Ascorbyl | tea | | |
| | Rapeseed | (Monoester | 100V | 2681 | | Emulsifier | gallate | acid | palmitate | extract | | |
| | oil | content) | 80% | 41% | (Subtotal) | Lecithin | P.G | G.A | V.C-P | T.E | Total | Result |
| Example 18 | 40.00 | | 12.00 | 6.00 | 18.00 | 40.00 | 2.00 | | | | 100.00 | Clear |
| Example 19 | 71.75 | | 5.00 | 2.50 | 7.50 | 20.00 | | | 0.25 | 0.50 | 100.00 | Clear |
| Comparative | 20.00 | | 12.00 | 6.00 | 18.00 | 60.00 | 2.00 | | | | 100.00 | Black/high |
| Example 10 | | | | | | | | | | | | viscosity |

### REFERENCE SIGNS LIST

9 Conventional antioxidant composition
AC Antioxidant component
E Emulsifier
W Aqueous phase portion
O Oil and fat component

1. An antioxidant composition comprising: an edible oil and fat; an antioxidant component sparingly soluble in an oil and fat; and an emulsifier,
wherein
the emulsifier comprises a diglycerol oleic acid ester having a monoester content of 40% or more and less than 70% and lecithin,
a content of the antioxidant component is 0.5 parts by mass or more and 40 parts by mass or less, a content of the diglycerol oleic acid ester is 1 part by mass or more and less than 70 parts by mass, and a content of the lecithin is 0.1 parts by mass or more and 40 parts by mass or less, with respect to 100 parts by mass of the antioxidant composition, and
the antioxidant component is solubilized by the emulsifier without using an aqueous solvent.

2. The antioxidant composition according to claim 1, wherein the antioxidant component is one type or two or more types selected from polyphenols, gallic acid, propyl gallate, and ascorbic acid fatty acid ester.

3. The antioxidant composition according to claim 1, further comprising one organic acid or two or more organic acids selected from citric acid, malic acid, phosphoric acid, polyphosphoric acid, metaphosphoric acid, lactic acid, succinic acid, fumaric acid, gluconic acid, tartaric acid, phytic acid, ascorbic acid, EDTA, and salts thereof.

4. An edible oil and fat for heating cooking to which the antioxidant composition according to claim 1 is added, wherein the antioxidant composition is contained in an amount of 0.01 parts by mass or more and 30 parts by mass or less in 100 parts by mass of a total of the antioxidant composition and the edible oil and fat.

5. An edible oil and fat for heating cooking to which the antioxidant composition according to claim 3 is added, wherein the antioxidant composition is contained in an amount of 0.01 parts by mass or more and 30 parts by mass or less in 100 parts by mass of a total of the antioxidant composition and the edible oil and fat.

6. An edible oil and fat for non-heating cooking to which the antioxidant composition according to claim 1 is added, wherein the antioxidant composition is contained in an amount of 0.01 parts by mass or more and 30 parts by mass or less in 100 parts by mass of a total of the antioxidant composition and the edible oil and fat.

7. An edible oil and fat for non-heating cooking to which the antioxidant composition according to claim 3 is added, wherein the antioxidant composition is contained in an amount of 0.01 parts by mass or more and 30 parts by mass or less in 100 parts by mass of a total of the antioxidant composition and the edible oil and fat.

8. The antioxidant composition according to claim 2, further comprising one organic acid or two or more organic acids selected from citric acid, malic acid, phosphoric acid polyphosphoric acid, metaphosphoric acid, lactic acid, succinic acid, fumaric acid, gluconic acid, tartaric acid, phytic acid, ascorbic acid, EDTA, and salts thereof.

9. An edible oil and fat for heating cooking to which the antioxidant composition according to claim 2 is added, wherein the antioxidant composition is contained in an amount of 0.01 parts by mass or more and 30 parts by mass or less in 100 parts by mass of a total of the antioxidant composition and the edible oil and fat.

10. An edible oil and fat for non-heating cooking to which the antioxidant composition according to claim 2 is added, wherein the antioxidant composition is contained in an amount of 0.01 parts by mass or more and 30 parts by mass or less in 100 parts by mass of a total of the antioxidant composition and the edible oil and fat.
